(19) United States
(12) Patent Application Publication
(10) Pub. No.: US 2011/0025588 A1
(43) Pub. Date: Feb. 3, 2011

(54) LIQUID CRYSTAL DISPLAY DEVICE

(75) Inventors: Jun Ma, Shanghai (CN); Zhihua Ling, Shanghai (CN); Xixi Luo, Shanghai (CN)

Correspondence Address: HARNESS, DICKEY & PIERCE, P.L.C., P.O. BOX 828, BLOOMFIELD HILLS, MI, 48303, US

(73) Assignee: Shanghai Tianma Micro-Electronics Co., Ltd., Shanghai (CN)

(21) Appl. No.: 12/937,162

(22) PCT Filed: Apr. 13, 2009
(86) PCT No.: PCT/CN2009/071249

§ 371 Date: Oct. 8, 2010

(30) Foreign Application Priority Data
Apr. 28, 2008 (CN) 200810043311.0

(51) Int. Cl. G09G 3/36

(52) U.S. Cl. 345/87

(57) ABSTRACT

A liquid crystal display device (1) includes an upper substrate (100), a lower substrate (200) and a liquid crystal layer (300) between the two substrates (100, 200). The upper substrate (100) has a common electrode (110). The lower substrate (200) has pixel electrodes (200) and there are many unit pixel regions defined on the lower substrate (200). Each unit pixel region has a transmissive region (230) and a reflective region (240). Liquid crystal molecules of the liquid crystal layer (300) are aligned perpendicularly to the surfaces of the substrates (100, 200) when no voltage is applied. There are many irregular protrusions (220) on the pixel electrodes (210). In the reflective region (240), there is a reflective metal layer (250) on the irregular protrusions (220).

This application claims the benefit of Chinese Patent Application No. 200810043311.0, filed with the Chinese Intellectual Property Office on Apr. 28, 2008, titled “Liquid Crystal Display Device”, the entire disclosure of which is hereby incorporated herein by reference.

### FIELD OF INVENTION

The present invention relates to a liquid crystal display device, and in particular to a liquid crystal display device which can realize both high visibility and wide viewing angle effect.

### BACKGROUND OF THE INVENTION

With the rapid development of manufacturing technology of thin-film transistors, liquid crystal display devices, which have the advantages of being slim, lightweight, electricity-saving, non-radiative and so on, are widespread applied to various electronic products such as computer, personal digital assistant (PDA), watch, notebook computer, digital camera, mobile phone and so on. Moreover, with positive research and development in the field and the employment of large-scale production facilities, the cost of manufacturing liquid crystal display device is being reduced continually, and the requirement for liquid crystal display devices is increasing dramatically.

The thin-film transistor liquid crystal display (TFT-LCD) makes use of the birefringence characteristic of liquid crystal molecules as a kind of anisotropic material, so as to realize gray scale display. Since the optical path difference changes along with the viewing position, the display characteristic of a liquid crystal display device is related to the viewing angle of a viewer. As a result, the liquid crystal display itself has the problem of viewing angle and the display quality varies with the viewer's viewing angle. Generally, the larger the viewing angle is, the lower the contrast is. With the development of large-sized liquid crystal displays, improving the contrast of viewing angle and the color uniformity is becoming more and more important.

In order to further expand the applicable areas and improve the qualities of liquid crystal displays, the current research on liquid crystal displays is focusing on how to enlarge viewing angle and improve response speed, and so on. In the prior art, many wide-angle technologies have been developed, such as in-plane switching technology (IPS), fringe field switching technology (FFS) and multi-domain vertical alignment (MVA).

Just like the wide-angle display, high visibility has been one of the research topics in the present phase, especially in the small sized liquid crystal displays which are employed outdoors. When the ambient light is very strong, the color fades in the liquid crystal display devices which display using backlight, but not in those display devices which display by reflecting ambient light. However, a display device with both transflective mode and wide-angle mode has complicated manufacturing processes, and the number of mask plates used is large and the yield is hard to control. All these lead to a high cost of manufacturing a wide-angle transflective liquid crystal panel.

In view of the problems in the prior art, the inventors have made positive research and improvement based on their vast experiences in the field and the spirit of seeking for greater perfection. As a result, the liquid crystal display device of the invention is attained.

### SUMMARY OF THE INVENTION

An object of the invention is to, in view of the above drawback in the prior art, provide a liquid crystal display device with high visibility and wide viewing angle.

In order to solve the problems above, the invention provides a liquid crystal display device comprising:
an upper substrate having a common electrode thereon;
a lower substrate having a pixel electrode thereon, a plurality of unit pixel regions being defined on the lower substrate, each unit pixel region including a transmissive region and a reflective region;
a liquid crystal layer between the upper substrate and the lower substrate, liquid crystal molecules of the liquid crystal layer being aligned perpendicularly to the surface of the upper substrate or the lower substrate when no voltage is applied;
wherein a plurality of irregular protrusions are arranged on the pixel electrode and there is a reflective metal layer on the surface of the plurality of irregular protrusions in the reflective region.

Optionally, there is a coating layer on the upper substrate of the reflective region. The coating layer is applied such that the thickness of the liquid crystal layer in the reflective region is approximately one half of that in the transmissive region.

The invention further discloses a liquid crystal display device comprising:
an upper substrate, on which a common electrode is formed;
a lower substrate having a plurality of unit pixel regions defined thereon;
a liquid crystal layer between the upper substrate and the lower substrate, liquid crystal molecules of the liquid crystal layer being aligned perpendicularly to the surface of the upper substrate or the lower substrate when no voltage is applied;
wherein a plurality of irregular protrusions are arranged on the lower substrate and there is a reflective metal layer on the surface of the lower substrate having the plurality of irregular protrusions.

As described above, the effect of high visibility and wide viewing angle can be realized simultaneously by means of the structural design of the liquid crystal display device according to the invention. The protrusions that have different sizes and are distributed irregularly can both make the perpendicularly aligned liquid crystal molecules of the liquid crystal layer form a multi-domain distribution structure and act as a reflector in the reflective region. In contrast to the prior art, the liquid crystal display device provided in the invention can simplify the layout process of protrusion layer on the upper substrate of existing products and the processes of etching and pattern defining the transparent electrodes and so on. Through the above reasonable design, a plurality of irregular protrusions of the lower substrate can simultaneously serve as reflectors and be used to anchor liquid crystal molecules of the liquid crystal layer in the wide viewing angle mode.

### BRIEF DESCRIPTION OF THE DRAWINGS

In the drawings:

FIG. 1a is schematic spatial structural view of an upper substrate corresponding to unit pixel regions of the liquid crystal display device according to the invention.

FIG. 1b is schematic spatial structural view of a lower substrate corresponding to unit pixel regions of the liquid crystal display device according to the invention.

FIG. 2 is a schematic sectional view of the structure of the liquid crystal display device according to the invention.

FIG. 3 is a top view of the liquid crystal display device corresponding to unit pixel regions of the structure of the liquid crystal display device according to the invention.

FIG. 4 is an iso-contrast contour of a transmissive region of the liquid crystal display device according to the invention.

FIG. 5 is a schematic simulated view of pixels of the liquid crystal display device according to the invention with different gray scales.

Reference numerals of various components in the drawings are listed below.

| | |
|---|---|
| Liquid crystal display device | 1 |
| Upper substrate 100 | common electrode 110 |
| Coating layer 120 | lower substrate 200 |
| Pixel electrode 210 | protrusion 220 |
| Big protrusion 220a | small protrusion 220b |
| Transmissive region 230 | reflective region 240 |
| Reflective layer 250 | liquid crystal layer 300 |

### DETAILED DESCRIPTION OF THE INVENTION

In order to explain the technical solutions, structural features, objectives and effects of the invention, a detailed description is given below in connection with the embodiments and the drawings.

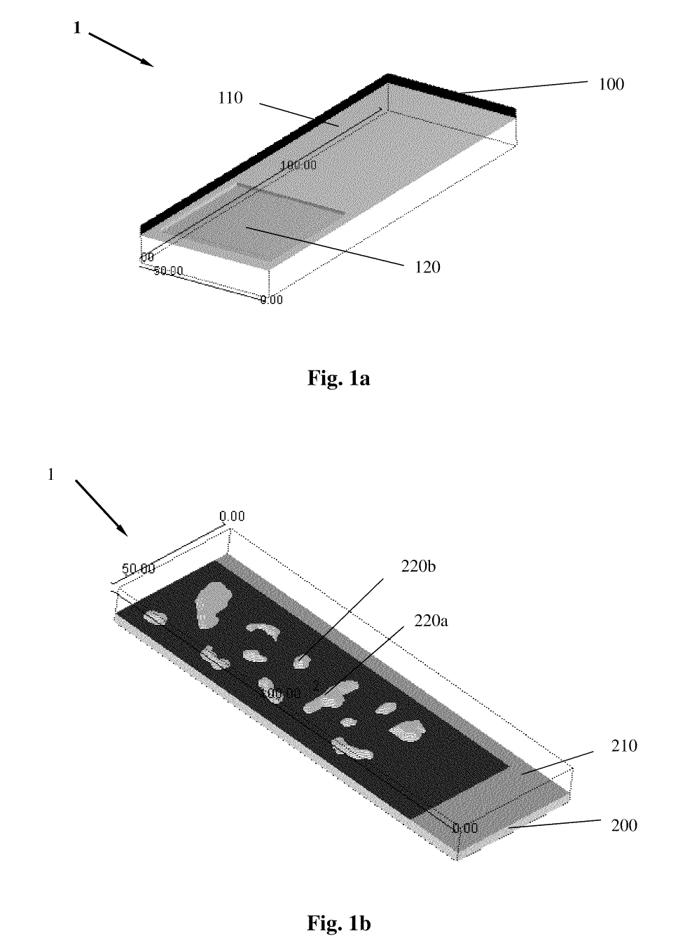

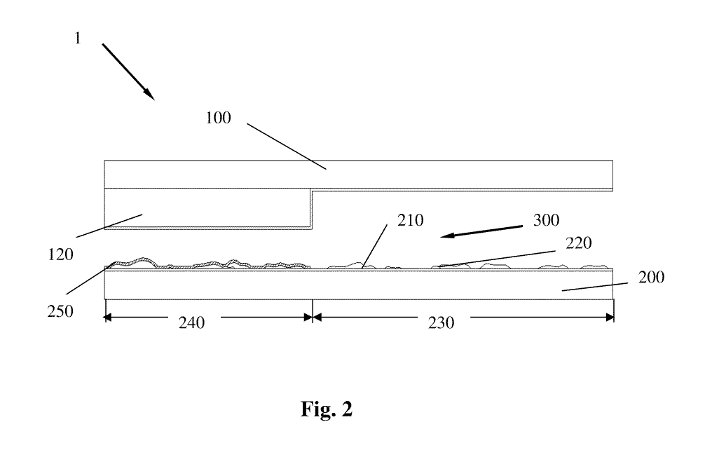

Referring to FIGS. 1a, 1b and 2, the liquid crystal display device 1 according to the invention includes a lower substrate 200, an upper substrate 100 facing to the lower substrate 200 and a liquid crystal layer 300 between the upper substrate 100 and the lower substrate 200.

A plurality of unit pixel regions are defined on the lower substrate 200. Specifically, each unit pixel region comprises a transmissive region 230 and a reflective region 240. A pixel electrode 210 is formed on the side of the lower substrate 200 facing the liquid crystal layer 300. The pixel electrode 210 could for example be made of Indium Tin Oxide (ITO) or Indium Zinc Oxide (IZO). A plurality of irregular protrusions 220 are disposed on the side of the pixel electrode 210 that faces the upper substrate 100. Specifically, a plurality of irregular protrusions 220 are disposed in the transmissive region 230 and the reflective region 240 of each unit pixel region. The irregular protrusions 220 are differently sized and the differences in size are reasonable. Specifically, the sizes are within the range from 8 μm to 20 μm. Therefore, the protrusions may be differentiated and defined as big protrusions 220a and small protrusions 220b. In the invention, the angle between the taper inclined surface of each protrusion 220 and the lower substrate 200 is defined as taper angle and the taper angle of the protrusion 220 is within the range from 10° to 25°. Meanwhile, a reflective metal layer, which serves as a reflective layer 250, is sputtered on the surface of the plurality of irregular protrusions 220 in the reflective region 240 on the surface of the lower substrate 200. In order to avoid the electrochemical erosion between the reflective metal serves as the reflective layer 250 and the transparent pixel electrode 210 underneath, the reflective metal is generally made of molybdenum, or neodymium-aluminum, for example.

A coating layer 120 is applied on the side of the upper substrate 100 facing the pixel electrode 210 at the reflective region 240. The coating layer 120 is an organic layer with the thickness of about 2 μm and is typically prepared using a transparent resin material. A common electrode 110 is provided at the side of the upper substrate 100 that faces to the liquid crystal layer 300. The common electrode 110 covers the surface of the coating layer 120. Of course, rather than covering the coating layer 120, the common electrode 110 could be provided between the upper substrate 100 and the coating layer 120.

Moreover, the coating layer 120 corresponds to the reflective region 240 having the plurality of irregular protrusions 220, so that the thickness of the liquid crystal layer 300 arranged to the reflective region 240 is approximately one half of that arranged to the transmissive region 230.

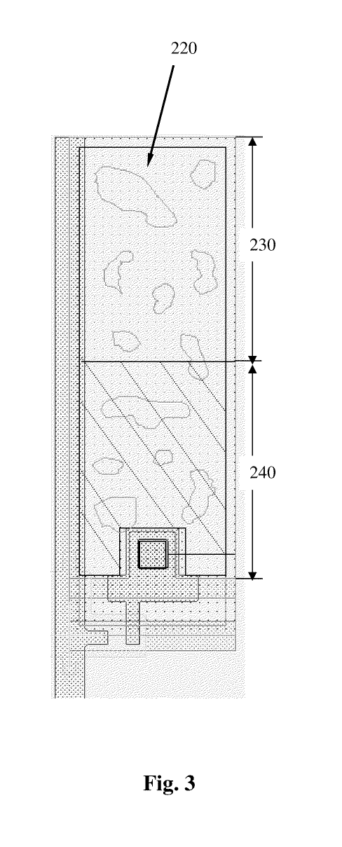

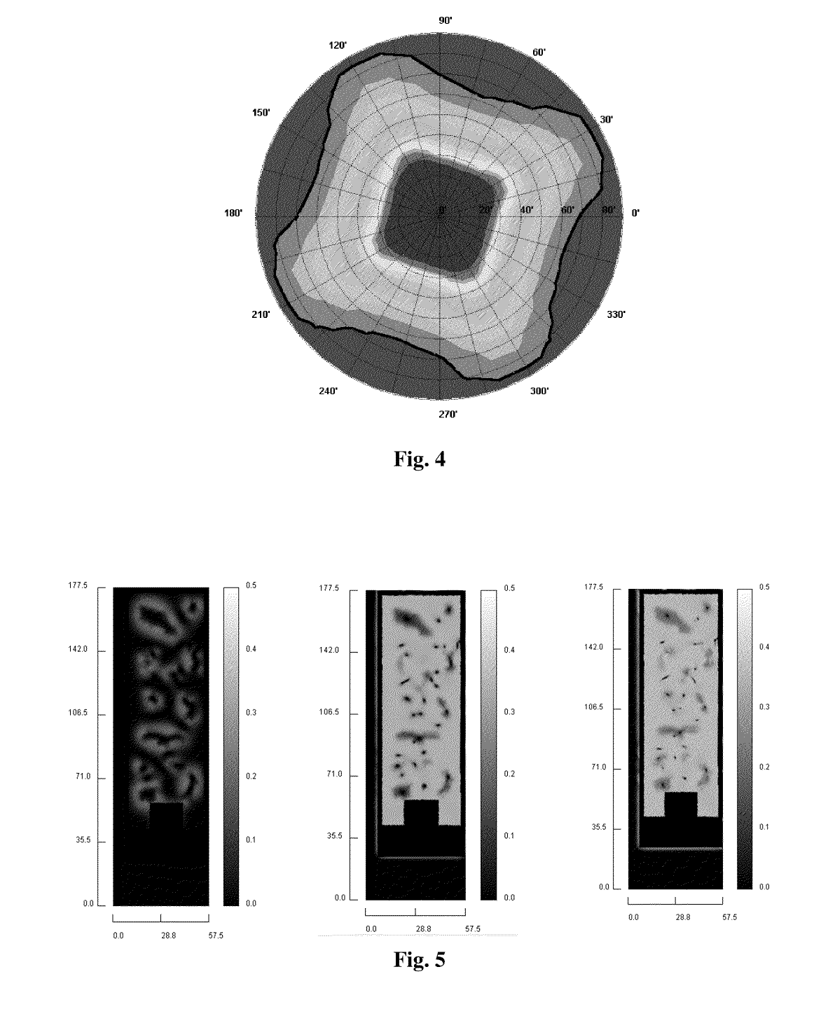

Referring to FIGS. 2 and 3 and in combination with FIG. 4, the plurality of irregular protrusions having different sizes are arranged at the side of the pixel electrode 210 that faces the common electrode 110. In the transmissive region 230 of the liquid crystal display device 1, liquid crystal molecules of the liquid crystal layer 300 on the surface of the irregular protrusions 220 will anchor along the inclined edge of the irregular protrusions 220 when no voltage is applied, thereby making the liquid crystal molecules of the liquid crystal layer 300 pre-incline. When a voltage is applied, the liquid crystal molecules of the liquid crystal layer 300 in the transmissive region 230 will turn along the existing pre-inclining direction. Since liquid crystal molecules pre-incline in a plurality of directions in the plane in which the liquid crystal molecules are aligned, liquid crystal molecules will turn towards any direction and the turning directions in this plane are multi-directional. Moreover, since the turning directions of liquid crystal molecules are multi-directional, it is possible to observe the liquid crystal display picture from various angles. Therefore, excellent display characteristics are provided to the liquid crystal display device 1 because of the structure of the irregular protrusions 220. FIG. 4 illustrates the iso-contrast contour of viewing angle characteristic of the liquid crystal display device 1.

Referring to FIGS. 2 and 3 and in combination with FIG. 5, in the reflective region 240 of the liquid crystal display device 1, liquid crystal molecules of the liquid crystal layer 300 will anchor along the inclined edge of the irregular protrusions 220 when no voltage is applied, thereby making the perpendicularly aligned liquid crystal molecules of the liquid crystal layer 300 pre-incline. When a voltage is applied, the liquid crystal molecules of the liquid crystal layer 300 in the reflective region 240 will turn along an existing pre-inclining direction. Considering the design of the plurality of irregular protrusions 220 of the pixel electrode 210, the position and size of each protrusion 220 is different from each other. Specifically, the size ranges from 8 μm to 20 μm. Therefore, when a voltage is applied, the advantageous domain formed by big protrusions 220a will be predominant and suppress domain distribution at the side of small protrusions 220b, thus improving optical transmittance of the liquid crystal display device 1 and causing the wide viewing angle characteristic on the basis of a larger optical transmittance of pixels. FIG. 5 illustrates schematic simulated view of pixels with the change of gray scale.

Referring to FIGS. 2 and 3 and in combination with FIG. 5, since the sizes of the irregular protrusions 220 are relatively small in overall and the distribution of the protrusions 220 is irregular, the irregular protrusions 220 can be used as lower bump reflectors of the reflective layer when a reflective display is performed. Unlike the situation in the transmissive region 230, when the structure of the protrusions 220 is used for reflective display, the reflective layer 250 covering the surface of the plurality of irregular protrusions 220 can diffuse the incident lights so that the liquid crystal display device 1 can display better.

Furthermore, given the above description, the coating layer 120 is applied on the side of the upper substrate 100 facing the pixel electrode 210 at the reflective region 240. The coating layer 120 is an organic layer with the thickness of about 2 μm and is typically made of a transparent resin material. The coating layer 120 serves to correspond to the reflective region 240 having the plurality of irregular protrusions 220 so that the thickness of the liquid crystal layer 300 arranged in the reflective region 240 is approximately one half of that of the liquid crystal layer 300 arranged in the transmissive region 230. Therefore, the optical path of the incident lights going through in the reflective region 240 is identical with that in the transmissive region 230.

To sum up, a high visibility and a wide viewing angle effect can be realized simultaneously by means of the structural design of the liquid crystal display device 1. The application of protrusions 200 that have different sizes and are distributed irregularly can simultaneously realize the effects of making the perpendicularly aligned liquid crystal molecules of the liquid crystal layer 300 form a multi-domain distribution structure and being used as a reflector in the reflective region. In contrast to the prior art, the adoption of the structure of the liquid crystal display device 1 can reduce the layout process of protrusion layer on the upper substrate 100 side of existing products and the processes of etching and pattern defining transparent electrodes and so on. Through the above reasonable design, the plurality of irregular protrusions 220 on the surface of the lower substrate 200 can simultaneously serve as reflectors and be used to anchor liquid crystal molecules of the liquid crystal layer 300 in a wide viewing angle mode. In this structure, when a voltage is applied, liquid crystal molecules will distribute irregularly in the plane on which the electrode is located, and the excellent viewing angle characteristic could be exhibited after a quarter-wave plate being used. Since the layout of protrusion layer on the upper substrate is reduced, the overall technological flow of the structure panel will be simplified, thus having a positive influence on the reduction of manufacturing cost and improvement of yield.

The invention also discloses a liquid crystal display device that comprises:
an upper substrate with a common electrode formed thereon;
a lower substrate having a plurality of unit pixel regions defined thereon;
a liquid crystal layer between the upper substrate and the lower substrate, liquid crystal molecules of the liquid crystal layer being aligned perpendicularly to the surface of the upper substrate or the lower substrate when no voltage is applied;
wherein a plurality of irregular protrusions are arranged on the lower substrate, and there is a reflective metal layer on the surface of the lower substrate having the plurality of irregular protrusions.

The difference of this liquid crystal display device from that previously described is that the irregular protrusions are distributed on the lower substrate, and the surface of the lower substrate with the plurality of irregular protrusions has a reflective metal layer.

Those ordinarily skilled in the art should appreciate that various modifications and alterations can be made herein without departing from the spirit or scope of the invention. Therefore, it is intended that the invention covers all such modifications and alterations provided that they fall within the scope of the appended claims and their equivalents.

What is claimed is:

1. A liquid crystal display device comprising:
an upper substrate having a common electrode thereon;
a lower substrate having a pixel electrode thereon, a plurality of unit pixel regions being defined on the lower substrate, each unit pixel region including a transmissive region and a reflective region;
a liquid crystal layer between the upper substrate and the lower substrate, liquid crystal molecules of the liquid crystal layer being aligned perpendicularly to the surface of the upper substrate or the lower substrate when no voltage is applied;
wherein a plurality of irregular protrusions are arranged on the pixel electrode, and there is a reflective metal layer on the surface of the plurality of irregular protrusions in the reflective region.

2. The liquid crystal display device according to claim 1, wherein there is a coating layer on the upper substrate of the reflective region, the coating layer is applied so that the thickness of the liquid crystal layer arranged in the reflective region is approximately one half of the thickness of the liquid crystal layer arranged in the transmissive region.

3. The liquid crystal display device according to claim 1, wherein the sizes of the plurality of irregular protrusions are from 8 μm to 20 μm.

4. The liquid crystal display device according to claim 1, wherein the angles formed between the inclined surfaces of the plurality of irregular protrusions and the lower substrate are from 10° to 25°.

5. The liquid crystal display device according to claim 1, wherein the reflective metal layer is made of molybdenum, or neodymium-aluminum structure.

6. A liquid crystal display device comprising:
an upper substrate, on which a common electrode is formed;
a lower substrate having a plurality of unit pixel regions defined thereon;
a liquid crystal layer between the upper substrate and the lower substrate, liquid crystal molecules of the liquid crystal layer being aligned perpendicularly to the surface of the upper substrate or the lower substrate when no voltage is applied;
wherein a plurality of irregular protrusions are arranged on the lower substrate, and there is a reflective metal layer on the surface of the lower substrate having the plurality of irregular protrusions.

7. The liquid crystal display device according to claim 6, wherein the sizes of the plurality of irregular protrusion are from 8 μm to 20 μm.

8. The liquid crystal display device according to claim 6, wherein the angles formed between the inclined surfaces of the plurality of irregular protrusions and the lower substrate are from 10° to 25°.

9. The liquid crystal display device according to claim 6, wherein the reflective metal layer is made of molybdenum, or neodymium-aluminum structure.
